(19) United States
(12) Patent Application Publication
(10) Pub. No.: US 2005/0221114 A1
(43) Pub. Date: Oct. 6, 2005

(54) Method for manufacturing pottery and resulting article of manufacture

(76) Inventor: Richie Del Watts, Starkville, MS (US)

Correspondence Address: KEVIN P. CROSBY;BRINKLEY MCNERNEY MORGAN SOLOMAN & TATUM LLP, 200 E. LAS OLAS BLVD, SUITE 1900, FORT LAUDERDALE, FL, 33301, US

(21) Appl. No.: 11/095,402

(22) Filed: Mar. 31, 2005

Related U.S. Application Data
(60) Provisional application No. 60/558,427, filed on Mar. 31, 2004.

(51) Int. Cl. B32B 9/00

(52) U.S. Cl. 428/688; 427/402; 427/372.2

(57) ABSTRACT

An article of pottery includes an article of greenware, a basecoat of non-reactive glaze disposed upon at least a portion of the greenware, at least one reactive glaze disposed in a desired pattern upon at least a portion of the basecoat, and preferably a transparent glaze disposed upon at least the reactive glaze(s). The basecoat is applied to the greenware and then preferably allowed to air dry. One or more reactive glazes are then applied over the dry basecoat in a desired pattern (e.g., a striped pattern). The reactive glazes are also preferably allowed to air dry and a transparent glaze is then preferably applied over at least the reactive glaze or glazes. After all the applied glazes have preferably air dried, the glazed article of greenware is fired at a high temperature, preferably in the range of 2,100° C. to 2,200° C., to produce the finished article of pottery.

### CROSS-REFERENCE TO RELATED APPLICATIONS

This application claims priority under 35 U.S.C. § 119(e) upon U.S. Provisional Application Ser. No. 60/558,427 filed on Mar. 31, 2004, which application is incorporated herein by reference.

### FIELD OF THE INVENTION

The present invention relates generally to the field of pottery. More particularly, the invention relates to an improved method for manufacturing decoratively glazed pottery and a resulting article of manufacture.

### BACKGROUND OF THE INVENTION

Slip casting is a known method for mass-producing pottery, ceramics, and earthenware vessels. “Slip” is defined in the art as non-viscous or thinned clay. Generally, slip casting consists of pouring a liquid clay slip into a plaster mold and allowing the clay to harden slightly. Once the plaster has absorbed most of the liquid from the outside layer of clay, the remaining slip is poured back into a storage vessel and the item is left to dry within the mold. When the item is sufficiently dry to allow for handling, it is removed from the mold. Excess clay that forms in the spaces between the halves (or more pieces) of the mold are removed and the item is allowed to air dry until it his hard and dry to the touch. Once the item has air-dried to this extent, it is called “greenware.” A description of this method can be found in U.S. Pat. No. 5,670,181 to Stokes, the disclosure of which is incorporated herein by this reference.

The greenware item is then preliminarily fired in a kiln. Once the greenware has been fired, it is referred to as “bisque.” The bisque is then glazed and fired again at higher temperature. An example of this method is described in U.S. Pat. No. 6,165,590 to Takagi et al., the disclosure of which is incorporated herein by this reference.

While the foregoing pottery fabrication method is conventionally used, it has certain limitations. For example, the conventional pottery fabrication method requires two firing steps, one to produce the bisque and the other to secure the glaze to the bisque. Thus, such an approach is time-consuming and, in a commercial setting, often requires two sets of kilns, one set for producing bisque and the other set for producing finished products. In addition, when using conventional pottery fabrication techniques, colors of the resulting pottery are not as vibrant or wide-ranging as often desired because bisque does not absorb decorative glazes very well, resulting in at least some of the glaze running down and often off the bisque before the glaze has a chance to dry completely. The running glaze may stick to the shelves on which the bisque has been placed to dry, potentially ruining the pottery and reducing manufacturing yields. Therefore, a need exists for a method of fabricating pottery, and resulting article of manufacture, that minimize the number of firing steps necessary to produce a finished product, while facilitating use of a wide variety of vibrant colors.

### BRIEF DESCRIPTION OF THE DRAWINGS

FIG. 1 is a flowchart of a method for fabricating pottery in accordance with the present invention.

FIG. 2 is a top plan view of an exemplary finished article of manufacture fabricated in accordance with the present invention.

FIG. 3 is a cross-sectional elevational view of the article of manufacture shown in FIG. 2.

### DETAILED DESCRIPTION OF PREFERRED EMBODIMENTS

Generally, the present invention encompasses a method for manufacturing articles of pottery and a resulting article of manufacture. A basecoat of a non-reactive glaze is applied to or otherwise disposed upon an article of greenware pottery. The non-reactive is then preferably allowed to air dry and at least one reactive glaze is applied over the basecoat in a desired pattern. The reactive glaze or glazes are also preferably allowed to air dry and a transparent glaze is preferably disposed upon at least the reactive glaze or glazes. After all the applied glazes have preferably air dried, the glazed article of greenware is fired at a high temperature, preferably in the range of 2,100° C. to 2,200° C., to produce the finished article of pottery. By producing an article of pottery in this manner, the present invention preferably reduces the number of firings down to a single firing, thereby minimizing the number of kilns and associated labor necessary to produce finished pottery products. In addition, by applying glazes directly to the greenware, a wider variety of more vibrant colors may be produced as compared to conventional techniques because pottery in the greenware stage is able to absorb or hold more glaze than pottery in a bisque stage.

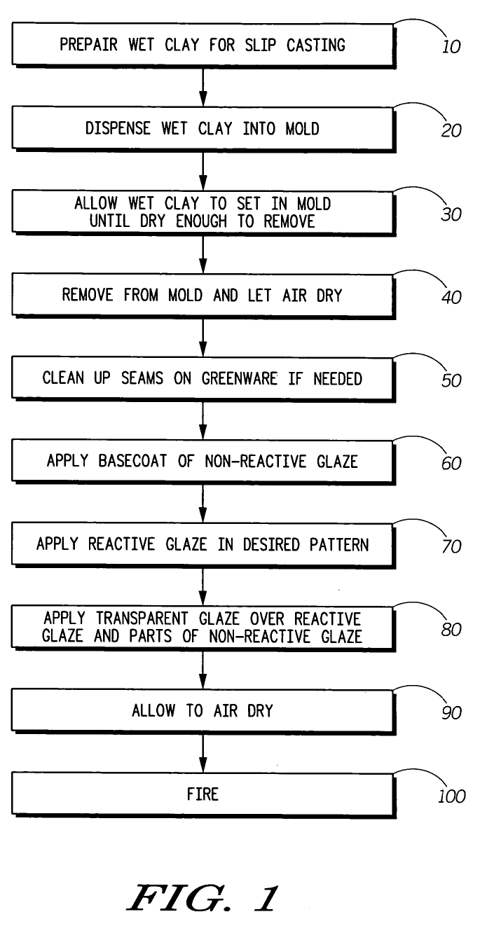

Referring now to FIG. 1, in the first step 10 of the method for glazing pottery, the wet clay is prepared for slip casting. The clay is preferably white stoneware clay from England. A suitable clay is commercially available from Seeley's Stoneware of Oneonta, N.Y., under the product name “White Sandstone Slip.” In the next step 20, the clay is dispensed into a mold of the desired shape of the pottery. The shapes may include, by way of example but not limitation, plates, cups, mugs, vases, pitchers, bowls, goblets, and a variety of other decorative items. The type or shape of the article upon which the glazing pattern is placed does not form any part of the present invention, it being understood that the invention can be carried out on any substrate susceptible of functional or ornamental glazing.

In step 30, the wet clay is allowed to set in the mold until it is dry enough to remove from the mold. The amount of time required for the clay to dry varies depending on many factors including, but not limited to, ambient temperature, the size of the article being made, humidity, etc. In step 40, the article of manufacture is removed from the mold and allowed to air dry. Once the clay has air dried sufficiently to allow for handling, it is called greenware 205. During the slip casting process, some of the wet clay may leak into the seams of the mold, leaving a ridge on the article as the clay dries. The excess clay forming this ridge may be removed from the greenware 205 in step 50. Next, in step 60 a basecoat of non-reactive, satin glaze 210 is applied on the entire surface of the article and the glaze 210 is allowed to air dry. The non-reactive glaze 210 can be in any desired color, and typically forms the background color in the finished pattern.

In step 70, a reactive glaze 215a, 215b of any number of desired colors is applied in any desired pattern. The reactive glaze 215a, 215b can be applied to the article 200 with a brush, a syringe, or any other implement that can be used to transfer the glaze from its container to the article 200 in the desired pattern. In step 80, a transparent glaze 220 is applied over those portions of the article 200 that are covered by the reactive glaze 215a, 215b and over a portion of the article 200 that is not covered by the reactive glaze 215a, 215b. Preferably, in step 80 a small portion of the article 200 that is covered only by the non-reactive glaze 210 is not covered by the reactive glaze 215a, 215b. One embodiment of step 80 comprises applying the reactive glaze 215a, 215b in stripes and, in a portion of the space between each stripe of reactive glaze 215a, 215b, applying the transparent glaze 220. In step 90, the article 200 is allowed to air dry. Finally, in step 100, the article is fired, preferably at 2,100-2,200° C. The combination of glazes in steps 70 and 80, and the temperature at which the article is fired in step 100, gives the article its distinctive appearance. Exemplary glazes suitable for use in implementing a preferred embodiment of the above-described manufacturing/glazing process are:

| | |
|---|---|
| Non-reactive glaze: | Spectrum's Satin Model No. 1122 |
| Reactive glaze: | Spectrum's Texture Bronze Model No. 1158 |
| Transparent glaze: | Spectrum's Transparent Glaze Model No. 1100 |

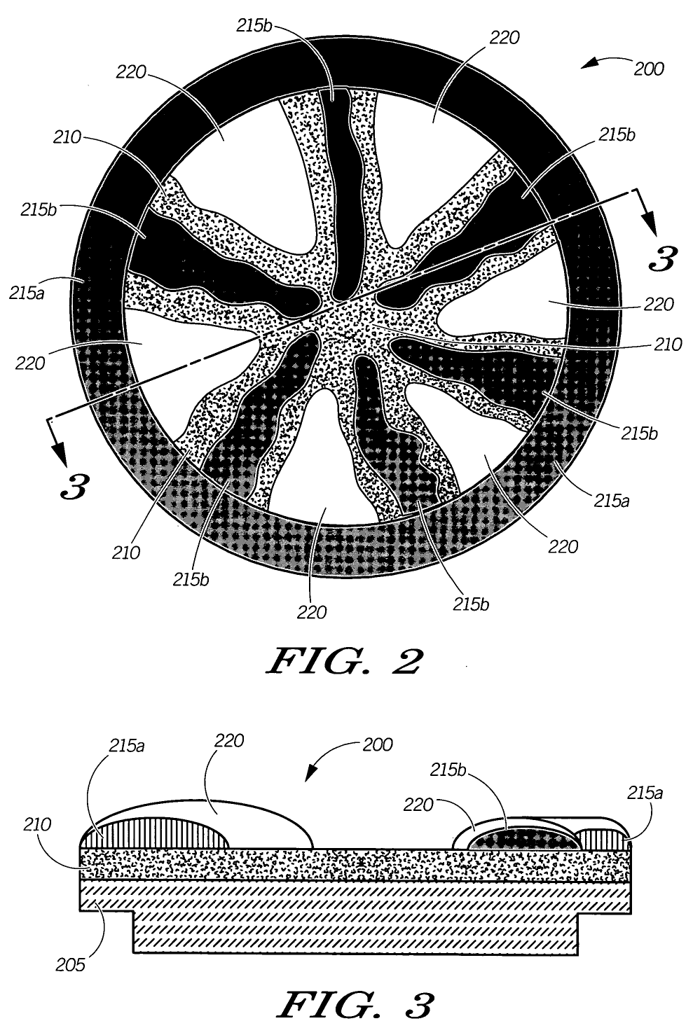

An exemplary finished article of manufacture 200 is depicted in FIGS. 2 and 3. The article of manufacture 200 can be any desired shape and the plate depicted in the figures is presented only by way of example and not limitation. A basecoat of non-reactive glaze 210 is applied on at least a portion of the greenware pottery 205 after the seams have been removed. Then, at least one reactive glaze 215a, 215b is applied in a desired pattern. There can be as many applications (e.g., different colors) of reactive glaze 215a, 215b as may be desired. The reference to only two colors of reactive glaze 215a, 215b is by way of example and not by way of limitation. A transparent glaze 220 is applied over the portions of the article of manufacture 200 that are covered by the reactive glaze 215a, 215b. Preferably, a transparent glaze 220 is also applied over a portion of the article of manufacture 200 that is not covered by the reactive glaze 215a, 215b, as in the stripe embodiment described above. After firing, the article of manufacture is ready for use.

The present invention encompasses a method of manufacturing articles of pottery and a corresponding article of manufacture. With this invention, higher yields of finished pottery products are capable as compared to conventional techniques because greenware is more absorbent than bisque; therefore, glazes applied to greenware do not run off the greenware and stick to shelves or other materials on which the greenware is placed to dry. In addition, with the present invention, finished pottery products are produced more quickly and less expensively than conventionally manufactured pottery products because only one kiln firing is required. Finally, due to applying the decorative glaze(s) directly to the greenware (or at least the base-coated greenware), the pottery produced in accordance with the present invention includes a wider variety of more vibrant colors than are producible using conventional pottery fabrication techniques.

Various modifications and alterations of this invention will become apparent to those skilled in the art without departing from the scope and spirit of this invention, and it is understood that this invention is not limited to the illustrative embodiments set forth hereinbefore.

1. A method for manufacturing an article of pottery, the method comprising:
providing an article of greenware;
applying a non-reactive glaze to at least a portion of the greenware to produce base-glazed greenware;
applying at least one reactive glaze in a desired pattern to at least a portion of the base-glazed greenware to produce decoratively-glazed greenware; and
firing the decoratively-glazed greenware.

2. The method of claim 1, further comprising:
applying a transparent glaze to at least a portion of the decoratively-glazed greenware to produce transparently-glazed greenware such that the transparent glaze covers the at least one reactive glaze; and
wherein the step of firing comprises firing the transparently-glazed greenware.

3. The method of claim 2, wherein the step of firing comprises:
firing the transparently-glazed greenware at a temperature in the range of 2,100° C. to 2,200° C.

4. The method of claim 2, wherein the step of applying the transparent glaze occurs after the decoratively-glazed greenware has air dried.

5. The method of claim 2, wherein the step of applying the transparent glaze to at least a portion of the decoratively-glazed greenware further comprises applying the transparent glaze to the decoratively-glazed greenware such that the transparent glaze further covers at least a portion of the non-reactive glaze that is not covered by the at least one reactive glaze.

6. The method of claim 1, wherein the step of applying the at least one reactive glaze occurs after the base-glazed greenware has air dried.

7. The method of claim 1, wherein the non-reactive glaze is applied to the entire article of greenware.

8. The method of claim 1, wherein the step of applying at least one reactive glaze to the base-glazed greenware comprises applying the at least one reactive glaze in a striped pattern to at least a portion of a visible surface of the base-glazed greenware to produce the decoratively-glazed greenware, each pair of stripes in the striped pattern being separated by an associated space.

9. The method of claim 8, further comprising:
applying a transparent glaze over each stripe of the at least one reactive glaze and over the non-reactive glaze residing on the base-glazed greenware in the associated space between each pair of stripes in the striped pattern to produce the transparently-glazed greenware; and
wherein the step of firing comprises firing the transparently-glazed greenware.

10. An article of pottery produced by the steps of:
providing an article of greenware;
applying a non-reactive glaze to at least a portion of the greenware to produce base-glazed greenware;
applying at least one reactive glaze in a desired pattern to at least a portion of the base-glazed greenware to produce decoratively-glazed greenware; and
firing the decoratively-glazed greenware.

11. The article of pottery of claim 10, wherein the article of pottery is produced by the further step of:
applying a transparent glaze to at least a portion of the decoratively-glazed greenware to produce transparently-glazed greenware such that the transparent glaze covers the at least one reactive glaze;
wherein the step of firing comprises firing the transparently-glazed greenware.

12. The article of pottery of claim 11, wherein the step of firing comprises:
firing the transparently-glazed greenware at a temperature in the range of 2,100° C. to 2,200° C.

13. The article of pottery of claim 11, wherein the step of applying the transparent glaze to at least a portion of the decoratively-glazed greenware further comprises applying the transparent glaze to the decoratively-glazed greenware such that the transparent glaze further covers at least a portion of the non-reactive glaze that is not covered by the at least one reactive glaze.

14. The article of pottery of claim 10, wherein the non-reactive glaze is applied to the entire article of greenware.

15. The article of pottery of claim 10, wherein the step of applying at least one reactive glaze to the base-glazed greenware comprises applying the at least one reactive glaze in a striped pattern to at least a portion of a visible surface of the base-glazed greenware to produce the decoratively-glazed greenware, each pair of stripes in the striped pattern being separated by an associated space.

16. The article of pottery of claim 15, wherein the article of pottery is produced by the further step of:
applying a transparent glaze over each stripe of the at least one reactive glaze and over the non-reactive glaze residing on the base-glazed greenware in the associated space between each pair of stripes in the striped pattern to produce the transparently-glazed greenware; and
wherein the step of firing comprises firing the transparently-glazed greenware.

17. An article of pottery comprising:
an article of greenware;
a basecoat of non-reactive glaze disposed upon at least a portion of the greenware; and
at least one reactive glaze disposed in a desired pattern upon at least a portion of the basecoat.

18. The article of pottery of claim 17, further comprising:
a transparent glaze disposed upon the at least one reactive glaze.

19. The article of potter of claim 18, wherein the transparent glaze is further disposed upon a portion of the basecoat that is not covered by the at least one reactive glaze.

20. The article of pottery of claim 17, wherein the at least one reactive glaze is disposed in a striped pattern upon at least a portion of the basecoat and comprises at least two different color reactive glazes.
